(19) United States
(12) Patent Application Publication
(10) Pub. No.: US 2014/0272435 A1
(43) Pub. Date: Sep. 18, 2014

(54) ANTI-STICK SURFACE COATINGS

(71) Applicant: DESIGNER MOLECULES, INC., San Diego, CA (US)

(72) Inventor: STEPHEN M DERSHEM, SAN DIEGO, CA (US)

(73) Assignee: DESIGNER MOLECULES, INC., SAN DIEGO, CA (US)

(21) Appl. No.: 13/840,977

(22) Filed: Mar. 15, 2013

(51) Int. Cl. C09D 183/04

(52) U.S. Cl. CPC C09D 183/04
USPC 428/447; 524/267; 524/269; 106/13; 106/2

(57) ABSTRACT

The present invention describes anti-stick coatings composed of carboxylic acid, carboxylate salt or thiol functionalized siloxanes. The compounds of this invention can be used as coatings on the surface of wind turbine blades, aircraft wings and fuselage, or on the surface of oil and gas platforms, ships, and other vehicles exposed to harsh weather conditions. These functionalized silicones can bond to the surface and create a new hydrophobic and oleophobic surface that is repellent to ice, oil, dirt and insects that may cause loss of efficiency, or impact the operation of the wind turbine, aircraft, ships, or offshore oil and gas platform that are exposed to the elements. These compounds also serve as anti-graffiti coatings, and as anti-stiction coatings for MEMS devices

### FIELD OF THE INVENTION

The present invention relates anti-stick coatings that can bond to the surface of mechanical structures, metals, composites, silicon wafers, paints and coatings as a means for protection of surfaces to act as a repellent to ice, oil, dirt and insects that may cause loss of efficiency or impact the operation of the specific part. In particular the present invention relates to functionalized silicone compounds that can cure with the resins used in the manufacture of wind turbines to prevent ice formation. In another aspect of this invention the functionalized silicones can be used as coatings on the surface of wind turbine blades, aircraft wings and fuselage, or on the surface of oil and gas platforms, ships, and other vehicles exposed to harsh weather conditions. The functionalized silicones may also be used as anti-graffiti coatings, and can also serve as anti-stiction coating for a MEMS device

### BACKGROUND OF THE INVENTION

In harsh climates exposure to the environment can pose many problems to the efficiency, normal operation, and safety of critical structures. The wings of the aircraft have many moving parts to control the flight, and icing can pose a threat to the aerodynamic performance of the aircraft and also safety in general. For example, ice formation on the body and in particular on the wings of aircraft can cause safety problems, and in extreme cases the ice-bound vehicle can no longer be operated. Icing in and around the engine of the aircraft in extreme cases can cause engine flameout.

In the case of wind turbines, ice formation will cause severe decrease in the efficiency of the structure, and often the wind turbine will have to be shut down and the ice removed. A look at the geography and wind patterns for the United States shows that the areas that have the optimum conditions for wind farms are in the cold weather areas of the northern Pacific coast, northern Atlantic coast, coast of Alaska, and the great lakes regions. These areas are known to have consistent and strong winds necessary to efficiently produce a great deal of electric power, and therefore make wind farms economically viable. Sustained winds are also very prevalent in the North Sea, and the northern European countries are taking advantage of this wind, and creating some of the largest wind turbines in the world. In all of these areas that have winds that can support wind farming are also very cold climate regions, icing is a major issue in these areas, and can cause a great deal of shut down time.

There are also many offshore oil and gas platforms in many harsh weather environments around the globe. Icing is also a major problem with these rigs. Many ships also need to navigate in cold weather regions around the world and are also subject to icing, also generally structures exposed to marine environments require coatings to protect them the corrosive nature of the sea. Automobiles and other vehicles are also in need of protection from ice and other debris, especially dirt and insects.

### Current Ice Removal Systems

Several current procedures are in place to combat the icing issues discussed so far. The most commonly used is to simply scrape the ice from the exposed surface with some suitable tool. This is rarely done with aircraft. In the case of wind turbines this requires the shut down of the turbine, and many long hours of labor to scrape off ice.

In the case of aircraft, deicing is usually conducted by applying aqueous ethylene glycol and/or propylene glycol solutions to the aircraft. Off course this is a temporary fix and is typically only done while the aircraft is stationary on the ground.

In flight, several procedures are also used. Many older and smaller aircraft are equipped with “deicing boots” (Goodrich Corporation); these consist of rubber membrane that are installed on some of the critical areas of the aircraft such as the leading edges of the wings and control surfaces (e.g. horizontal and vertical stabilizers). As atmospheric icing occurs and ice builds up, a pneumatic system inflates the boots with compressed air. This expansion in size cracks any ice that has accumulated, and this ice is then blown away by the airflow. A major problem with boots is that they develop cracks and holes and have to be replaced every couple of years.

The “ThermaWing” (Kelly Aerospace), is an electrical ice protection system. ThermaWing used a flexible, electrically conductive, graphite foil attached to a wing's leading edge. Once activated the heat generated melts the ice, and keeps the wings warm as to prevent further ice build up.

One of the most common systems used particularly on modern jumbo jets is the bleed air system. In this anti-icing system the waste heat from the engines is bled off into tubes routed through the wings, engine inlets and tail surfaces. This keeps flight surfaces above freezing temperatures and free from ice.

For wind turbines there is a tremendous amount of research in the area of icing prevention technologies. They can be classified in two categories: active and passive.

Most of the active de-icing methods are adapted directly from the aeronautical industry. They consist of thermal, chemical, and impulse de-icing.

One of the most commonly used active techniques is by implementing rotor blade heating systems, either by using hot air or heated wires to melt the ice off. Of course, the wind turbine has to be shut down during this deicing procedure, and as a result the wind turbine consumes power rather than producing it during this procedure.

An example of a passive icing prevention that has been tried is to use black-coated wind turbine blades. This approach would take advantage of the heat absorbing capacity of the dark colored surface to prevent ice from forming.

Another passive ice prevention technique that has been tried is to coat the turbine blades with an anti-adhesive coating such as Teflon®.

### Development of Coatings

The ideal solution to the problem of icing and for that matter other debris on the surface of aircraft, wind turbine blades, ships and oil and gas platforms is to develop a special coating which will adhere to the surface and prevent the ice build up and other debris in the first place. If anything, the coating would allow the current deicing systems to work more efficiently, and create less down time due to severe icing. This would be the simplest and most cost effective solution to a very big problem, and there is a tremendous amount of ongoing research to come up with an ideal coating.

The use of a deicing coating on an aircraft or wind turbine would be a passive method of controlling the ice accretion, which can be integrated into existing designs and structures. Also, unlike electrical heaters, the addition of a coating onto a structure would not add additional energy cost to the system. Furthermore, unlike deicing fluids, most coatings are long lasting and are not environmentally hazardous.

Various companies around the world have pursued several approaches to this coating problem. Many of these anti-stiction coatings depend on fluorocarbons, which may be very effective to a certain degree; however, to date none of these coatings have been widely accepted for use.

A serious concern connected to some of the deicing materials is their potential human and environmental toxicity. Poly-fluorinated hydrocarbons, with more than about four carbons in the backbone, are known to bio-accumulate (i.e. to become concentrated in living organisms, and no naturally occurring biological mechanisms exist that can eliminate these compounds from the body once they are absorbed). These materials, therefore, are considered to pose a risk to personal health as well as to the environment.

Accordingly, there remains a need to develop environmentally friendly compounds and resin systems to be used as coatings, and specifically as anti-adhesive coatings or deicing coatings.

Anti-graffiti coatings for the most part are very similar to anti-icing coatings. For an anti-graffiti coating the requirements are that the material be very hydrophobic, oleophobic, adhere very well to the substrate, environmentally friendly, have good resistance to UV aging and weathering, and have good cleaning efficiency. This is why the use of fluorinated compounds is so prevalent in anti-graffiti coatings. Pertluorocarbons have very low surface energy and prevent the oil or water based paint from wetting the surface, thus the graffiti cannot stick to the surface and is easily removed by wiping it off.

Micro-electromechanical systems (MEMS) are very small, integrated devices that combine electrical and mechanical components and replicate the structure and function of meter-scale devices used in day-to-day life. They range in size from the sub-micron to the millimeter level. Inkjet-printer cartridges, accelerometers, miniature robots, micro-engines, inertial sensors, micro-mirrors, micro-actuators, optical scanners, fluid pumps, and transducers are some of the examples of current day MEMS device applications. Newer applications are emerging as the existing technology is applied to the miniaturization and integration of conventional devices. Despite the exciting growth predictions for the future of MEMS technologies, the difficulty in controlling surface forces is a critical impediment to the fabrication and operation of many MEMS devices. Surface phenomena such as wear and stiction (permanent adhesion) of the micro moving parts, often restrict the operational environment and limit the lifetime of these devices. Protecting MEMS against friction, wear and stiction is thus major challenge. A well-known problem in the fabrication of MEMS devices from surface micro-machining is stiction, which occurs when surface adhesion forces are higher than the mechanical restoring force of the microstructure. When a device is removed from the aqueous solution after wet etching of an underlying sacrificial layer, the liquid meniscus formed on hydrophilic surfaces pulls the microstructure towards the substrate and stiction occurs. Another more difficult problem is in-use stiction, which occurs during operation when microstructures come into contact (intentionally or accidentally). Capillary forces, electrostatic attraction, and direct chemical bonding may cause in-use stiction. In order to alleviate the stiction-related problems without compromising with functionality of MEMS device, both the topography and the chemical composition of the contacting surfaces must be controlled. The most effective approach to achieve this would be to develop suitable surface coatings technology for MEMS. The application of low-energy surface coatings would be required to eliminate or reduce capillary, chemical bonding and electrostatic forces between the contacting microstructure surfaces of the MEMS device. For a coating system to be suitable for the MEMS application, it needs to have the following characteristics. The coating should have excellent adhesion on the surfaces of the micro-components; it should be hydrophobic in nature and thin enough not to bridge structural features of the MEMS device.

### BRIEF SUMMARY OF THE INVENTION

The present invention provides for coatings to be used as protection of weatherable surfaces from ice buildup, oil, debris, and insects. The invention is also very suited to be used as anti-graffiti coating for surfaces that are prone to vandalism. The invention is also very suited for use as anti-stiction coating for micro-electromechanical systems (MEMS devices).

The invention provides for an article prone to harsh weather conditions such as wind, rain, ice, and airborne debris; and a protective coating on said surface comprising a carboxylate salt, carboxylic acid, or thiol functionalized polysiloxane. The functionalized siloxane can optionally also contain an unsaturated polymerizable moiety that can form additional covalent bonds.

In one embodiment of the invention the said functionalized siloxane compounds can be coated onto said weatherable surface. This can be accomplished by spraying; brushing or rolling said material on said surface, either neat, utilizing a suitable solvent, or as an aqueous dispersion. Said surface to be coated includes, but is not limited to wind turbine components, aircraft components, ships, oil and gas platforms, automobiles, antennas, cables, satellite dishes and the like. Said surface can also be metal, metal alloy, composite, plastic, or another coating.

In another embodiment of the invention said functionalized siloxane can be incorporated into a resin system, which is then applied to the said surface such as via a painting procedure. Said functionalized siloxane compounds of the invention have low surface energy and naturally tend to migrate to the air surface. Once cured, said coating provides the necessary protection from the elements.

In yet another embodiment of the invention, said functionalized siloxane can be sprayed, brushed, or rolled onto a B-staged composite prepreg. During the final curing procedure the said functionalized siloxane will cure to the surface and provide the necessary anti-stick properties.

In yet another embodiment of the invention, said functionalized siloxane can be deposited on the surface of a silicon wafer such as for MEMS device, using various chemical vapor deposition techniques to form an anti-stiction coating on said surface.

### DETAILED DESCRIPTION OF THE INVENTION

Unless specific definitions are provided, the nomenclatures utilized in connection with, and the laboratory procedures and techniques of analytical chemistry, synthetic organic and inorganic chemistry described herein are those known in the art, such as those set forth in “IUPAC Compendium of Chemical Terminology: IUPAC Recommendations (The Gold Book)” (McNaught ed.; International Union of Pure and Applied Chemistry, 2^{nd} Ed., 1997) and “Compendium of Polymer Terminology and Nomenclature: IUPAC Recommendations 2008”(Jones et al., eds; International Union of Pure and Applied Chemistry, 2009). Standard chemical symbols are used interchangeably with the full names represented by such symbols. Thus, for example, the terms “hydrogen” and “H” are understood to have identical meaning. Standard techniques may be used for chemical syntheses, chemical analyses, and formulation.

### DEFINITIONS

“About” as used herein means that a number referred to as “about” comprises the recited number plus or minus 1-10% of that recited number. For example, “about” 100 degrees can mean 95-105 degrees or as few as 99-101 degrees depending on the situation. Whenever it appears herein, a numerical range such as “1 to 20” refers to each integer in the given range; e.g., “1 to 20 carbon atoms” means that an alkyl group can contain only 1 carbon atom, 2 carbon atoms, 3 carbon atoms, etc., up to and including 20 carbon atoms (although the term “alkyl” also includes instances where no numerical range of carbon atoms is designated).

“Adhesive” or “adhesive compound” as used herein, refers to any substance that can adhere or bond two items together. Implicit in the definition of an “adhesive composition” or “adhesive formulation” is the fact that the composition or formulation is a combination or mixture of more than one species, component or compound, which can include adhesive monomers, oligomers, and/or polymers along with other materials, whereas an “adhesive compound” refers to a single species, such as an adhesive polymer or oligomer.

More specifically, adhesive composition refers to un-cured mixtures in which the individual components in the mixture retain the chemical and physical characteristics of the original individual components of which the mixture is made. Adhesive compositions are typically malleable and may be liquids, paste, gel or another form that can be applied to an item so that it can be bonded to another item.

“Cured adhesive,” “cured adhesive composition” or “cured adhesive compound” refers to adhesives components and mixtures obtained from reactive curable original compound(s) or mixture(s) thereof which have undergone a chemical and/or physical changes such that the original compound(s) or mixture(s) is (are) transformed into a solid, substantially non-flowing material. A typical curing process may involve crosslinking.

“Curable” means that an original compound(s) or composition material(s) can be transformed into a solid, substantially non-flowing material by means of chemical reaction, crosslinking, radiation crosslinking, or the like. Thus, adhesive compositions of the invention are curable, but unless otherwise specified, the original compound(s) or composition material(s) is (are) not cured.

“Thermoset,” as used herein, refers to the ability of a compound, composition or other material to irreversibly “cure” resulting in a single tridimensional network that has greater strength and less solubility compared to the non-cured product. Thermoset materials are typically polymers that may be cured, for example, through heat (e.g. above 200° Celsius), via a chemical reaction (e.g. epoxy ring-opening, free-radical polymerization, etc.), or through irradiation (e.g. visible light, U.V., or X-ray irradiation).

Thermoset materials, such as thermoset polymers or resins, are typically liquid or malleable forms prior to curing, and therefore may be molded or shaped into their final form, and/or used as adhesives. Curing transforms the thermoset resin into a rigid infusible and insoluble solid or rubber by a cross-linking process. Thus, energy and/or catalysts are typically added that cause the molecular chains to react at chemically active sites (unsaturated or epoxy sites, for example), linking the polymer chains into a rigid, 3-D structure. The cross-linking process forms molecules with a higher molecular weight and resultant higher melting point. During the reaction, when the molecular weight of the polymer has increased to a point such that the melting point is higher than the surrounding ambient temperature, the polymer becomes a solid material.

“Cross-linking,” as used herein, refers to the attachment of two or more oligomer or longer polymer chains by bridges of an element, a molecular group, a compound, or another oligomer or polymer. Crosslinking may take place upon heating, some crosslinking processes may also occur at room temperature or a lower temperature. As cross-linking density is increased, the properties of a material can be changed from thermoplastic to thermosetting.

The term “monomer” refers to a molecule that can undergo polymerization or copolymerization thereby contributing constitutional units to the essential structure of a macromolecule (a polymer).

“Polymer” and “polymer compound” are used interchangeably herein, to refer generally to the combined the products of a single chemical polymerization reaction. Polymers are produced by combining monomer subunits into a covalently bonded chain. Polymers that contain only a single type of monomer are known as “homopolymers,” while polymers containing a mixture of monomers are known as “copolymers.”

As used herein, “aliphatic” refers to any alkyl, alkenyl, cycloalkyl, or cycloalkenyl moiety.

“Aromatic hydrocarbon” or “aromatic” as used herein, refers to compounds having one or more benzene rings.

“Alkane,” as used herein, refers to saturated straight chain, branched or cyclic hydrocarbons having only single bonds. Alkanes have general formula CₙH₂ₙ₊₂. “Cycloalkane,” refers to an alkane having one or more rings in its structure.

As used herein, “alkyl” refers to straight or branched chain hydrocarbyl groups having from 1 up to about 500 carbon atoms. “Lower alkyl” refers generally to alkyl groups having 1 to 6 carbon atoms. The terms “alkyl” and “substituted alkyl” include, respectively, substituted and unsubstituted C₁-C₅₀₀ straight chain saturated aliphatic hydrocarbon groups, substituted and unsubstituted C₂-C₂₀₀ straight chain unsaturated aliphatic hydrocarbon groups, substituted and unsubstituted C₄-C₁₀₀ branched saturated aliphatic hydrocarbon groups, substituted and unsubstituted C₁-C₅₀₀ branched unsaturated aliphatic hydrocarbon groups.

“Substituted alkyl” refers to alkyl moieties bearing substituents that include but are not limited to alkyl, alkenyl, alkynyl, hydroxy, oxo, alkoxy, mercapto, cycloalkyl, substituted cycloalkyl, heterocyclic, substituted heterocyclic, aryl, substituted aryl (e.g., arylC₁₋₁₀alkyl or arylC₁₋₁₀alkyloxy), heteroaryl, substituted heteroaryl (e.g., heteroarylC₁₋₁₀ alkyl), aryloxy, substituted aryloxy, halogen, haloalkyl (e.g., trihalomethyl), cyano, nitro, nitrone, amino, amido, carbamoyl, ═O, ═CH—, —C(O)H, —C(O)O—, —C(O)—, —S—, —S(O)₂—, —OC(O)—O—, —NR—C(O)—, —NR—C(O)—NR—, —OC(O)—NR—, where R is H or lower alkyl, acyl, oxyacyl, carboxyl, carbamate, sulfonyl, sulfonamide, sulfuryl, C₁₋₁₀alkylthio, arylC₁₋₁₀ alkylthio, C₁₋₁₀alkylamino, arylC₁₋₁₀alkylamino, N-aryl-N—C₁₋₁₀alkylamino, C₁₋₁₀alkyl carbonyl, aryl C₁₋₁₀alkylcarbonyl, C₁₋₁₀alkylcarboxy, aryl C₁₋₁₀alkylcarboxy, C₁₋₁₀alkyl carbonylamino, aryl C₁₋₁₀alkylcarbonylamino, tetrahydrofuryl, morpholinyl, piperazinyl, and hydroxypyronyl.

In addition, as used herein “C₃₆” refers to all possible structural isomers of a 36 carbon aliphatic moiety, including branched isomers and cyclic isomers with up to three carbon-carbon double bonds in the backbone. One non-limiting example of a moiety that the definition of “C₃₆” refers to is the moiety comprising a cyclohexane-based core and four long “arms” attached to the core, as demonstrated by the following structure:

[chemical structure]

As used herein, “cycloalkyl” refers to cyclic ring-containing groups containing in the range of about 3 up to about 20 carbon atoms, typically 3 to about 15 carbon atoms. In certain embodiments, cycloalkyl groups have in the range of about 4 up to about 12 carbon atoms, and in yet further embodiments, cycloalkyl groups have in the range of about 5 up to about 8 carbon atoms. and “substituted cycloalkyl” refers to cycloalkyl groups further bearing one or more substituents as set forth below.

As used herein, the term “aryl” represents an unsubstituted, mono-, di- or trisubstituted monocyclic, polycyclic, biaryl aromatic groups covalently attached at any ring position capable of forming a stable covalent bond, certain preferred points of attachment being apparent to those skilled in the art (e.g., 3-phenyl, 4-naphtyl and the like).

As used herein, “hetero” refers to groups or moieties containing one or more heteroatoms such as N, O, Si and S. Thus, for example “heterocyclic” refers to cyclic (i.e., ring-containing) groups having e.g. N, O, Si or S as part of the ring structure, and having in the range of 3 up to 14 carbon atoms. “Heteroaryl” and “heteroalkyl” moieties are aryl and alkyl groups, respectively, containing e.g. N, O, Si or S as part of their structure. The terms “heteroaryl”, “heterocycle” or “heterocyclic” refer to a monovalent unsaturated group having a single ring or multiple condensed rings, from 1 to 8 carbon atoms and from 1 to 4 hetero atoms selected from nitrogen, sulfur or oxygen within the ring.

Hetero-containing groups may also be substituted. For example, “substituted heterocyclic” refers to a ring-containing group having in the range of 3 up to 14 carbon atoms that contains one or more heteroatoms and also bears one or more substituents, as set forth above.

As used herein, the term “phenol” includes compounds having one or more phenolic functions per molecule. The terms aliphatic, cycloaliphatic and aromatic, when used to describe phenols, refers to phenols to which aliphatic, cycloaliphatic and aromatic residues or combinations of these backbones are attached by direct bonding or ring fusion.

As used herein, “alkenyl,” “alkene” or “olefin” refers to straight or branched chain unsaturated hydrocarbyl groups having at least one carbon-carbon double bond, and having in the range of about 2 up to 500 carbon atoms. “Substituted alkenyl” refers to alkenyl groups further bearing one or more substituents as set forth above.

As used herein, “alkylene” refers to a divalent alkyl moiety, and “oxyalkylene” refers to an alkylene moiety containing at least one oxygen atom instead of a methylene (CH₂) unit. “Substituted alkylene” and “substituted oxyalkylene” refer to alkylene and oxyalkylene groups further bearing one or more substituents as set forth above.

As used herein, “acyl” refers to alkyl-carbonyl species.

“Allyl” as used herein, refers to refers to a compound bearing at least one moiety having the structure:

[chemical structure]

“Imide” as used herein, refers to a functional group having two carbonyl groups bound to a primary amine or ammonia.

“Polyimides” are polymers of imide-containing monomers. Polyimides are typically linear or cyclic. Non-limiting examples of linear and cyclic (e.g. an aromatic heterocyclic polyimide) polyimides are shown below for illustrative purposes.

[chemical structure]

“Maleimide,” as used herein, refers to an N-substituted maleimide having the formula as shown below:

[chemical structure]

where R is an aromatic, heteroaromatic, aliphatic, or polymeric moiety.

“Bismaleimide” or “BMI”, as used herein, refers to compound in which two imide moieties are linked by a bridge, i.e. a compound a polyimide having the general structure shown below:

[chemical structure]

where R is an aromatic, heteroaromatic, aliphatic, or polymeric moiety.

BMIs can cure through an addition rather than a condensation reaction, thus avoiding problems resulting from the formation of volatiles. BMIs can be cured by a vinyl-type polymerization of a pre-polymer terminated with two maleimide groups.

As used herein, the term “acrylate” refers to a compound bearing at least one moiety having the structure:

[chemical structure]

As used herein, the term “acrylamide” refers to a compound bearing at least one moiety having the structure:

[chemical structure]

As used herein, the term “methacrylate” refers to a compound bearing at least one moiety having the structure:

[chemical structure]

As used herein, the term “methacrylamide” refers to a compound bearing at least one moiety having the structure:

[chemical structure]

As used herein, “maleate” refers to a compound bearing at least one moiety having the structure:

[chemical structure]

As used herein, the term “acyloxy benzoate” or “phenyl ester” refers to a compound bearing at least one moiety having the structure:

[chemical structure]

wherein R=H, lower alkyl, or aryl.

As used herein, the term “citraconimide” refers to a compound bearing at least one moiety having the structure:

[chemical structure]

“Itaconate”, as used herein refers to a compound bearing at least one moiety having the structure:

[chemical structure]

As used herein, the terms “halogen,” “halide,” or “halo” include fluorine, chlorine, bromine, and iodine.

As used herein, “siloxane” refers to any compound containing a Si—O moiety. Siloxanes may be either linear or cyclic. In certain embodiments, siloxanes of the invention include 2 or more repeating units of Si—O. Exemplary cyclic siloxanes include hexamethylcyclotrisiloxane, octamethylcyclotetrasiloxane, decamethylcyclopentasiloxane, dodecanmethylcyclohexasiloxane and the like.

As used herein, “oxiranylene” or “epoxy” refers to divalent moieties having the structure:

[chemical structure]

The term “epoxy” also refers to thermosetting epoxide polymers that cure by polymerization and crosslinking when mixed with a catalyzing agent or “hardener,” also referred to as a “curing agent” or “curative.” Epoxies of the present invention include, but are not limited to aliphatic, cycloaliphatic, glycidyl ether, glycidyl ester, glycidyl amine epoxies, and the like, and combinations thereof.

As used herein, the term “oxetane” refers to a compound bearing at least one moiety having the structure:

[chemical structure]

As used herein, the term “vinyl ether” refers to a compound bearing at least one moiety having the structure:

[chemical structure]

As used herein, the term “vinyl ester” refers to a compound bearing at least one moiety having the structure:

[chemical structure]

As used herein, “styrenic” refers to a compound bearing at least one moiety having the structure:

[chemical structure]

“Oxazoline” as used herein, refers to a compound bearing at least one moiety having the structure:

[chemical structure]

“Benzoxazine” as used herein, refers to a compound bearing at least one moiety having the structure:

[chemical structure]

“Fumarate” as used herein, refers to a compound bearing at least one moiety having the structure:

[chemical structure]

“Cyanate ester” as used herein, refers to a compound bearing at least one moiety having the structure:

[chemical structure]

“Cyanoacrylate” as used herein, refers to a compound bearing at least one moiety having the structure:

[chemical structure]

As used herein, the term “free radical initiator” refers to any chemical species which, upon exposure to sufficient energy (e.g., light, heat, or the like), decomposes into parts, which are uncharged, but every one of such part possesses at least one unpaired electron.

As used herein, the term “coupling agent” refers to chemical species that are capable of bonding to a mineral surface and which also contain polymerizably reactive functional group(s) so as to enable interaction with the adhesive composition. Coupling agents thus facilitate linkage of the die-attach paste to the substrate to which it is applied.

The present invention provides carboxylate salt, carboxylic acid or thiol-terminated siloxane compounds which can be used as surface (anti-stick) coating to prevent ice formation, and or build up of other debris from dirt, oil or insects. The compounds of the invention are also sufficiently hydrophobic, oleophobic, and have very low surface tension so that they are very good materials to be used as anti-graffiti coatings, and also as anti-stiction coatings for MEMS devices

The present invention provides a compound of any one the formulae I-IX:

[chemical structure]

[chemical structure]

wherein: each R and R₁ is independently C₁ to C₈ alkyl; or phenyl, R₂ is selected from straight or branched chain alkyl, substituted alkyl, alkenyl, substituted alkenyl, alkynyl, substituted alkynyl, cycloalkyl, substituted cycloalkyl, aromatic, substituted aromatic, heterocyclic, substituted heterocyclic, heteroaromatic, or substituted heteroaromatic, R₃ is hydrogen or methyl, and R₄ is selected from straight or branched chain alkyl, substituted alkyl, aromatic, or substituted aromatic; n is 3 to 500; and m is 0 to 100.

In certain embodiments, R is C₁ to C₆ alkyl. In other embodiments, R is C₁ to C₄ alkyl. In yet other embodiments, R is methyl.

In certain embodiments, R₁ is C₁ to C₆ alkyl. In other embodiments, R₁ is C₂ to C₄ alkyl. In yet other embodiments, R₁ is butyl.

R₂ is typically a C₁-C₅₀, C₂-C₃₀, C₂-C₁₂ or C₂-C₈ alkyl, substituted alkyl, alkenyl, substituted alkenyl, alkynyl, substituted alkynyl, cycloalkyl, substituted cycloalkyl, heterocyclic, substituted heterocyclic, heteroaromatic, or substituted heteroaromatic.

In certain embodiments, is R₂ is selected from optionally substituted methyl, ethyl, ethenyl, methylethenyl, n-propyl, isopropyl, propenyl, butyl, isobutyl, sec-butyl, tert-butyl, butenyl, pentyl, pentenyl, hexyl, hexenyl, octyl, or octenyl; ethylallyl, ethyloctenyl, ethyldodecenyl, ethyloctadecenyl, cyclohexane, cyclohexene, bicyclohexene, norbornenyl, phenyl, or naphthyl. In certain other embodiments. R₂ is an optionally substituted maleimide, cyclohexane, cyclohexene, bicyclohexene, and benzoic acid.

In yet another embodiment, R₂ has the formula:

(CH₂)ₘR₅(R₆)ₘ

wherein, R₅ is a heteroatom;

R₆ is optionally substituted alkyl;

and each m is independently 1-12.

In certain aspects to this embodiment, R₂ is an optionally substituted C₂-C₄ amino or sulfenyl moiety. In certain embodiments, of the invention, R is methyl. In certain aspects R₁ is butyl. In certain other embodiments, R is methyl and R₁ is butyl.

In yet further embodiments, R₂ is C₄-C₁₂ straight or branched chain alkyl, substituted alkyl, alkenyl, substituted alkenyl, alkynyl, substituted alkynyl, cycloalkyl, substituted cycloalkyl, heterocyclic, substituted heterocyclic, heteroaromatic, or substituted heteroaromatic, and n is at least about 10 to at least about 250.

In certain embodiments of the invention, n is at least about 10, at least about 20, at least about 50 or at least about 100. In other embodiments, n is about 10 to about 500, about 20 to about 250, or about 50 to about 100.

In certain aspects of the invention, R₂ comprises at least one carboxylic acid, vinyl or ester side chain.

In one embodiment, the invention provides a compound of formula I where R is methyl; R₁ is C₁-C₆ alkyl; R₂ is C₄-C₁₂ straight or branched chain alkyl, substituted alkyl, alkenyl, substituted alkenyl, alkynyl, substituted alkynyl, cycloalkyl, substituted cycloalkyl, heterocyclic, substituted heterocyclic, heteroaromatic, or substituted heteroaromatic; and n is at least about 10 to at least about 250.

Exemplary compounds of formula I according to the present invention include:

[chemical structure]

[chemical structure]

[chemical structure]

[chemical structure]

Also provided by the invention is compound having the formula X:

[chemical structure]

where each R and R₁ is independently C₁ to C₈ alkyl or phenyl; X+ is a cation, L is C₂ to C₁₀ alkyl, alkenyl, cycloalkyl, cycloalkenyl, aryl, naphthyl; n is to 500 and m is 0 to 100, and the X+ cation is selected from ammonium, alkyl ammonium, dialkyl ammonium, trialkyl ammonium, tetraalkyl ammonium, cycloalkyl ammonium, aryl ammonium, substituted aryl ammonium, pyridinium, substituted pyridinium, or a mono-valent or poly-valent metal cation selected from lithium, sodium, potassium, cesium, magnesium, calcium, strontium, barium, copper, zinc, aluminum, tin, or bismuth.

Exemplary compounds of formula X according to the present invention include:

[chemical structure]

In some embodiments, n is 1 to about 100. In other embodiments, n is 1 to about 75. In other embodiments, n is I to about 50. In still other embodiments, n is 1 to about 25.

While not intending to be limited to a particular theory, the carboxylic acid moiety, the salt or the thiol of the compound of formulae I-X may help to anchor the functionalized siloxane to metal or composite surfaces. It is well knows that metals often have thin oxide layers that are slightly basic, and these oxides react with acids to form salts. Accordingly, in some embodiments of the invention, R₂ may include additional acidic groups, particularly carboxylic acid side chains. The functionalized siloxane may also include a polymerizable moiety that can physically bond to a resin system.

The siloxane tail is very hydrophobic with very low surface tension, and naturally migrates to the air surface providing a very hydrophobic and oleophobic coating that offers protection to the surface exposed to the elements.

In addition to the acid base reaction of the metal oxide layer with the carboxylic acid moiety of the functionalized siloxane, additional reactions and physical forces also play a part in the adhesion of these compounds with various surfaces. For inert plastic surfaces, such as Teflon, polyethylene, polypropylene and polybutadiene, the compounds of the invention may adhere to or wet the surface through Van der Waals forces. The functionalized siloxanes that have a free-radically polymerizable moiety may also react with and cure with any unsaturated sites on the inert plastic surface. Furthermore, unsaturated sites on the plastic may also form hydroperoxides, which can cure with the polymerizable moiety of the functionalized siloxane to form a covalent bond. For certain other plastic surfaces, which are based on unsaturated polyesters, or other vinyl moiety, there is always some residual uncured material that can form a covalent bond with the polymerizable functionalized siloxane. Thermoset plastics based on maleimides, may also have residual uncured sites that are able to react with the unsaturated moiety of the functionalized siloxane to form a covalent bond, furthermore, a thiol functionalized siloxane is also capable of reacting with the maleimide double bond via the Michael addition reaction. Epoxy based thermosets may also have residual epoxy groups that are unreacted, these sites are vulnerable to attach by the carboxylic acid group of the invention compounds to form an ester linkage, furthermore, any residual epoxy is also able to react with a thiol group of the invention compounds to undergo a ring opening reaction to form B-hydroxysulfides.

In one embodiment of the invention the functionalized siloxane compounds can be coated onto a weatherable surface. This can be accomplished by spraying, brushing or rolling the material said surface, either neat, utilizing a suitable solvent, or as an aqueous dispersion. The surface to be coated includes, but is not limited to wind turbine components, aircraft components, ships, oil and gas platforms, automobiles and the like. The components to be coated include, but are not limited to wind turbine blades, aircraft wings, fuselage, propeller blades, offshore oil and gas platforms, ships hulls, automotive components, satellite dishes, antennas and electric cables.

In the modern world many components used in aircraft, wind turbines and ships are constructed of composite materials. The use of fiberglass, E-glass, WindStrand™ and carbon fibers are very prevalent. The resins used most often to make these composite materials include polyesters, vinyl esters, epoxy resins and bismaleimides. The methods to make these composites include resins transfer molding (RTM), vacuum assisted resin transfer molding (VARTM), SCRIMP™ infusion, and vacuum bag prepreg molding.

To make composite materials, typically fibers are impregnated with resin during a molding operation to make a B-staged material or prepreg. In another embodiment of the invention the functionalized siloxane compounds of the said invention are sprayed, brushed or rolled on the prepreg composite material during the final curing process. During the cure stage the functionalized siloxane will bond with and provide protection for the surface of the composite material of the formulation.

Accordingly, the present invention also provides adhesive compositions containing the functionalized siloxanes of formulae I-X. Said composition comprises:

a thermosetting resin,

a quantity of the functionalized siloxane of at least one of formula I-X sufficient to provide protection to the surface upon application of the adhesive composition to a substrate; and at least one curing initiator.

In one embodiment, the quantity of the functionalized siloxane ranges from 0.01 to about 25 weight percent (wt %) based on total weight of the composition. In another embodiment, the functionalized siloxane is present at an amount of 0.1 to about 10 wt % bases on the total weight of the composition. In yet another embodiment, the functionalized siloxane is present at an amount of 0.5 to about 5 wt % based on the total weight of the composition.

A wide variety of thermosetting chemistries are contemplated for use as thermosetting resins in the practice of the invention. Such chemistries include, for example epoxies, oxetanes, phenolics, resoles, oxazolines, benzoxazines, monomaleimides, bismaleimides, polymaleimides, cyanate esters, acrylates, methacrylates, maleates, fumarates, itaconates, vinyl esters, vinyl ethers, cyanoacrylates, or styrenics, or combinations thereof.

In certain embodiments, the thermosetting resins are epoxies, oxetanes, phenolics, resoles, oxazolines, benzoxazines, monomaleimides, bismaleimides, silicone resins, polymaleimides, cyanate esters, acrylates, methacrylates, fumarates, vinyl esters, or styrenics, or combinations thereof.

In certain other embodiments, the thermosetting resins are epoxies, monomaleimides, bismaleimides, polymaleimides, cyanate esters or combinations thereof.

In still other embodiments, the thermosetting resins are monomaleimides, bismaleimides, or polymaleimides, or combinations thereof.

The coating compositions of this invention may also incorporate further constituents such as non-reactive silicones, dyes, pigments, fillers, solubilizing agents, curing initiators, antioxidants, as well as suitable organic solvents.

It is known to those skilled in the art, that many coating techniques are available to apply a material to a surface. The use of each technique is going to depend on many factors including; the type of coating that is used, the type of surface to be coated, and the size or the surface area of the object that is going to be coated. Coating techniques contemplated for use with the invention include, but are not limited to; spraying, brushing, rolling, dipping, chemical vapor deposition, electrocoating, e-coating, cathodic electrodeposition, electrophoretic coating, electrophoretic painting, and such. It is also known to those skilled in the art that often multiple coating applications are necessary to provide the desired properties and protection.

In still further embodiments of the invention, methods are provided for coating a functionalized siloxane compound of the said invention to a weatherable surface, wherein the functionalized siloxane is applied to the surface neat, as an aqueous dispersion, or diluted in an organic solvent. In these forms the compounds of the invention may be applied directly to the mold and function as both a mold release and chemically bound protective coating of the final molded part.

According to further embodiment of the invention another method is provided for coating a functionalized siloxane compound of the said invention to a weatherable surface, including the steps of: a) mixing a suitable quantity of the functionalized siloxane in a resin system (which may include, but not limited to: epoxies, oxetanes, phenolics, resoles, oxazolines, benzoxazines, monomaleimides, bismaleimides, polymaleimides, silicone resins, cyanate esters, acrylates, methacrylates, maleates, fumarates, itaconates, vinyl esters, vinyl ethers, cyanoacrylates, or styrenics, or combinations thereof), b) spraying or brushing the mixed resin system on the surface to be treated, c) followed by a curing step with a suitable catalyst.

The functionalized siloxane compounds contemplated for use in the practice of the invention are prepared according to organic chemistry techniques well known to those skilled in the art.

While this invention has been described with respect to certain embodiments, it should be clear that other modifications and variations would be possible without departing from the spirit of this invention.

### EXAMPLES

### Example 1

### Preparation of Itaconate Acid-Ester

A 250-mL, one-neck flask was charged with 11.2 g (0.10 mol) of itaconic anhydride and 40.0 g (approximately 0.04 mol) of MCR-C12 (Gelest Inc., Morrisville, Pa.). This mixture was stirred at 65° C. for twenty-one hours. The mixture was allowed to cool to room temperature, followed by the addition of 100 mL of octane. The mixture was then flash filtered over 15 g of silica gel. The octane was removed under reduced pressure to yield 40.5 g of a clear, colorless liquid. The material was analyzed by FTIR and found to have prominent absorptions at 2961, 1746, 1704, 1257, 1017, 790, and 700 wavenumbers.

### Example 2

### Ice Adhesion Test on Polished Aluminum Surface

The support used was polished aluminum bars with an average surface roughness of approximately 5000 Å. The surface was cleaned with acetone and allowed to dry. A 10-wt % solution of the sample was prepared in acetone. This solution was sprayed on to the aluminum surface and allowed to completely dry (single coating), and then placed in a freezer at −20° C. Uniform water droplets were placed on the aluminum surface using a pipette and then frozen again at −20° C. for up to one hour. The samples were then taken out of the freezer and placed in a Styrofoam box containing dry ice to prevent thawing while the adhesion test was performed.

The adhesion test is performed by pushing at 30° from the horizontal using a handheld force gage equipped with a wedge which was also kept in a dry ice acetone bath prior to use. The results of the test using various compounds of the invention can be seen in Table 1.

The functionalized siloxane coatings used in these experiments are synthesized according to synthetic organic techniques well known to those skilled in the art from readily available carbinol terminated polydimethyl siloxanes (Gelest Inc., Morrisville, Pa.). The C12 (Avg. M.W. ˜1000) and C18 (Avg. M.W. ˜5000) refer to mono-carbinol terminated polydimethylsiloxanes. The C61 (Avg. M.W. ˜1000) and C62 (Avg. M.W. ˜5000) refer to mono-dicarbinol terminated polydimethylsiloxanes. Buehler release agent (Buehler Company, Lake Bluff, Ill.) is commonly used in the lab to prevent resins from sticking to a mold during curing operations, this material is composed of a small amount of silicones in isooctane or in combination with other hydrocarbons.

TABLE 1
Adhesion on Polished Aluminum Surface

| Part # | Coating | Average Adhesion (lbs) |
|---|---|---|
| 1 | None | 4.5 |
| 2 | C62 Itaconate | 0 |
| 3 | C18 Mercaptopropionate | 0 |
| 4 | C18 Maleate | 0 |
| 5 | C62 Mercaptopropionate | 0 |
| 6 | C12 Mercaptopropionate | 0 |
| 7 | C61 Mercaptopropionate | 0 |
| 8 | Buehler Release Agent | 2.1 |
| 9 | C18 Itaconate | 0 |
| 10 | C12 Itaconate | 0 |
| 11 | C61 Maleate | 0 |
| 12 | C61 Itaconate | 0 |

The data in Table 1 clearly shows that the uncoated aluminum surface in part #1 shows the highest force required to remove the ice as expected. The aluminum coated with the functionalized siloxane compounds of the invention all required no force to remove the ice, even though only a single coating was used. Surprisingly, a commonly used release agent in part #8 did not do well in that it required an average of 2.1 lbs of force to remove the ice from the coated aluminum surface.

### Example 3

### Ice Adhesion Test on Gelcoat

A gelcoat based on unsaturated polyester resin is applied to aluminum surface to form a cured polymer surface. The compounds of the invention are flooded on to the surface of the gelcoat, and the excess was removed prior to testing. The adhesion testing was again performed according to the procedure in example 1. The adhesion of ice on the coated surface was conducted after the excess anti-stiction coating was removed. To test how well the anti-stiction material has bonded to the gelcoat, the surface was vigorously wiped ten times with a paper towel and the ice adhesion test was repeated. The adhesion test was conducted a third time with additional vigorous wiping. The results of the adhesion test are summarized in Table 2.

TABLE 2
Adhesion on Gelcoat Surface

| | | Adhesion | | Adhesion |
|---|---|---|---|---|
| | | (lbs) | Adhesion | (lbs) |
| | | Excess | (lbs) | Additional |
| Part # | Coating | Removal | 10x Wipes | 10x Wipes |
| 1 | None | 2.8 | 3.7 | 2.75 |
| 2 | C61 Maleate | 1.1 | 2.3 | 1.2 |
| 3 | C18 Itaconate | 0.17 | 2.92 | 1.25 |
| 4 | C12 | 1.25 | 1.2 | 0.5 |
| | Mercaptopropionate | | | |
| 5 | C62 Itaconate | 0.25 | 2.1 | 1.05 |
| 6 | C18 Maleate | 0.42 | 1.67 | 0.92 |
| 7 | C61 Itaconate | 0.67 | 2.25 | 1.1 |
| 8 | C18 Mercaptopropionate | 0.5 | 2.67 | 0.67 |
| 9 | C61 Mercaptopropionate | 0.5 | 1.2 | 0.83 |
| 10 | C62 Mercaptopropionate | 0.33 | 1.67 | 1 |
| 11 | C12 Itaconate | 0.42 | 0.75 | 1.42 |
| 12 | Buehler Release Agent | 0.67 | 1.2 | 0.75 |

This experiment demonstrates that the compounds of the invention do clearly adhere and form a chemical bond to the surface of the gelcoat and are not easily removed as would be the case if it were just adsorbed on to the surface. The force required to remove the ice from the coated gelcoat surface is typically ⅓ the force that is required to remove the ice from the untreated gelcoat surface. The results should be even better with multiple coating of the functionalized siloxanes.

### Example 4

### Anti-Graffiti Test on Gelcoat

A gelcoat based on unsaturated polyester resin was applied to aluminum surface to form a cured polymer surface. The compounds of the invention were flooded on to the surface of the gelcoat, and the excess was removed prior to testing. The surface was marked with a Sharpe permanent marker (Sanford LP, Oak Brook, Ill.) and allowed to dry. Soft lint-free wipes were used to wipe the mark off of the gelcoat surface.

What is claimed is:

1. An article comprising:
a surface exposed to precipitation, ice, a marine environment, airborne debris, insects, graffiti, stiction forces; and
a coating disposed on said surface comprising of at least one functionalized siloxane and additives.

2. The composition of claim 1, wherein said functionalized siloxane comprises a compound having the formula: [chemical structure] [chemical structure]
wherein:
each R and R₁ is independently C₁ to C₈ alkyl or phenyl,
R₂ is selected from straight or branched chain alkyl, substituted alkyl, alkenyl, substituted alkenyl, alkynyl, substituted alkynyl, cycloalkyl, substituted cycloalkyl, aromatic, substituted aromatic, heterocyclic, substituted heterocyclic, heteroaromatic, or substituted heteroaromatic;
R₃ is hydrogen or methyl;
R₄ is selected from straight or branched chain alkyl, substituted alkyl, aromatic, or substituted aromatic;
n is 3 to 500;
and m is 0 to 100.

3. The compound of claim 2, wherein R is methyl and R₁ is butyl.

4. The compound of claim 2, wherein: R₂ is optionally substituted methyl, ethyl, ethenyl, methylethenyl, n-propyl, isopropyl, propenyl, butyl, isobutyl, sec-butyl, tert-butyl, butenyl, pentyl, pentenyl, hexyl, hexenyl, octyl, or octenyl; ethylallyl, ethyloctenyl, ethyldodecenyl, ethyloctadecenyl, cyclohexane, cyclohexene, bicyclohexene, norbornenyl, phenyl, or naphthyl.

5. The compound of claim 2, wherein: R₂ has the formula (CH₂)m R₅ (R₆)m;
R₅ is a heteroatom;
R₆ is optionally substituted alkyl; and
each m is independently 1-12.

6. The compound of claim 2, wherein R₂ is optionally substituted methyl, ethyl, ethenyl, n-propyl, isopropyl, propenyl, butyl, isobutyl, sec-butyl, tert-butyl, butenyl, pentyl, pentenyl, hexyl, hexenyl, octyl, or octenyl.

7. The compound of claim 2, wherein R₂ is maleimide, cyclohexane, cyclohexene, bicyclohexene, or benzoic acid.

8. The compound of claim 2, wherein R₂ has the formula (CH₂)ₘR₄ (R₅)ₘ;
wherein R₄ is a heteroatom;
R is optionally substituted alkyl; and
each m is independently 1-12.

9. The compound of claim 2, wherein;
R₂ is C₄-C₁₂ straight or branched chain alkyl, substituted alkyl, alkenyl, substituted alkenyl, alkynyl, substituted alkynyl, cycloalkyl, substituted cycloalkyl, heterocyclic, substituted heterocyclic, heteroaromatic, or substituted heteroaromatic; and
n is at least about 10 to at least about 250.

10. The compound of claim 2 or 9, wherein R₂ comprises at least one vinyl group.

11. The compound of claim 2, selected from:

[chemical structure]

[chemical structure]

[chemical structure]

[chemical structure]

12. The article of claim 1, wherein the functionalized siloxane comprises a compound having the formula: [chemical structure]
wherein:
each R and R₁ is independently C₁ to C₈ alkyl or phenyl;
X+ is a cation selected from ammonium, alkyl ammonium, dialkyl ammonium, trialkyl ammonium, tetraalkyl ammonium, cycloalkyl ammonium, aryl ammonium, substituted aryl ammonium, pyridinium, substituted pyridinium, or a mono-valent or poly-valent metal cation selected from lithium, sodium, potassium, cesium, magnesium, calcium, strontium, barium, copper, zinc, aluminum, tin, or bismuth;
L is C₂ to C₁₀ alkyl, alkenyl, cycloalkyl, cycloalkenyl, aryl, and naphthyl;
n is to 500; and
m is 0 to 100.

13. The functionalized siloxane of claim 12, selected from:

[chemical structure]

14. The article of claim 1, wherein the additives are curable resins.

15. The composition of claim 14, wherein the curable resins are selected from epoxies, oxetanes, oxazolines, benzoxazines, resoles, maleimides, cyanate esters, acrylates, methacrylates, maleates, fumarates, itaconates, vinyl esters, vinyl ethers, cyanoacrylates, or styrenics silicones or combinations thereof.

16. The article of claim 1, wherein said additives comprises: oils, dyes, pigments, solubilizing agents, solvents, curing initiators, antioxidants, and fillers.

17. The article of claim 1, wherein said surface comprises: wind turbine components, aircraft components, automotive components, antenna components, satellite dish components, oil and gas platform components, and marine craft components.

18. The article of claim 1, wherein said surface is a microelectromechanical system (MEMS device).

19. The article of claim 1, wherein said coating is applied to said surface comprising of the techniques of: spraying, brushing, rolling, dipping, chemical vapor deposition, electrocoating, e-coating, cathodic electrodeposition, electrophoretic coating, and electrophoretic painting.

20. The article of claim 19, wherein said coating is applied to said surface, and optionally a further heat-curing step is applied.
